(19) United States
(12) Patent Application Publication
(10) Pub. No.: US 2005/0142378 A1
(43) Pub. Date: Jun. 30, 2005

(54) Perpendicular magnetic recording medium having alternatively layered structure of Co alloy and Pt thin film, its production method and apparatus

(75) Inventors: Hiroaki Nemoto, Kanagawa (JP); Yuzuru Hosoe, Tokyo (JP); Yoshiyuki Hirayama, Tokyo (JP); Mineaki Kodama, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Netherlands, B.V., AZ Amsterdam (NL)

(21) Appl. No.: 11/012,835

(22) Filed: Dec. 14, 2004

(30) Foreign Application Priority Data
Dec. 25, 2003 (JP) 2003-429427

(51) Int. Cl. B05D 5/12; G11B 5/64

(52) U.S. Cl. 428/670; 428/694 TS; 427/128

(57) ABSTRACT

Embodiments of the invention provide a granular medium structure and a significant increase of the Kᵤ value of a magnetic material at the same time using a non-metal material, thereby obtaining a magnetic recording medium capable of high density recording. In one embodiment, a magnetic metal grain in a granular magnetic film made of magnetic metal grains and a non-magnetic material is obtained by laminating a ferromagnetic exchange metallic element that contains mainly Co or Fe and a Pt element alternately and the lamination period is set between about 0.35 nm and 0.9 nm, preferably between about 0.4 nm and 0.55 nm.

### CROSS-REFERENCES TO RELATED APPLICATIONS

This application claims priority from Japanese Patent Application No. JP 2003-429427, filed Dec. 25, 2003, the entire disclosure of which is incorporated herein by reference.

### BACKGROUND OF THE INVENTION

The present invention relates to a magnetic recording medium used for an information recording apparatus that records, stores, and reproduces information magnetically, as well as a method and apparatus for manufacturing the magnetic recording medium.

Along with the appearance of high performance computers in recent years, higher density recording performance has also been demanded for magnetic recording hard-disk drives (HDD). The areal recording density of those hard-disk drives (HDD) has increased rapidly to meet the demand. However, in the process for increasing the areal recording density, a problem has often arisen, namely, information recorded magnetically in the magnetizing direction is erased under the influence of ambient thermal energy. As is well known, in order to realize high density recording on a recording medium, the diameter of magnetic grains existing in the recording film must be reduced as much as possible and a crystal grain boundary region is provided between those magnetic grains to weaken the magnetic coupling between those grains, thereby reducing the noise of the recorded magnetization information. On the other hand, because the thermal energy required for reversing the magnetizing direction is in proportion to the cubic volume of the respective magnetic grains, the resistance to the thermal energy goes lower if the cubic volume of the magnetic grains is reduced. This results in the following problem: the magnetic grains that retain the recorded magnetizing direction come to be disabled to retain the magnetizing direction just after the information is recorded, so that the reproducing output goes lower with time, for example. This phenomenon is referred to as thermal decay of magnetization.

One of the methods for solving the above problems directly is to increase the magnetic anisotropy energy (Kᵤ) of the subject magnetic recording film that retains information in the magnetizing direction. The magnetic anisotropy energy (Kᵤ) is a physical property value for representing the stability of magnetizing direction, that is, the difficulty of reversing the magnetizing direction. The magnetic anisotropy energy (Kᵤ) is determined by the crystal structure of magnetic grains and/or the material of the magnetic grains. If the ambient temperature is defined as T, the cubic volume of respective isolated magnetic grains is defined as V, and the Boltzmann constant is defined as k_{B}, respectively, the magnetization reversal comes to occur more often under the influence of thermal fluctuation in reverse proportion to the value of (Kᵤ)·V)/(k_{B}·T). Such frequency occurrence of thermal decay of magnetization can therefore be suppressed if the Kᵤ is increased to compensate for the reduction of the V value.

Currently, a perpendicular magnetic recording method, which is expected to be employed instead of the longitudinal magnetic recording method applied to the present products, is under research and development. The perpendicular magnetic recording method enables the self-demagnetizing field from adjacent bits to stabilize the magnetization when in high density recording, so that the method is regarded to be better than the longitudinal magnetic recording method.

At such a background, a superlattice film is now focused. The superlattice film is well known to have large magnetic anisotropy energy and its magnetic easy axis is oriented perpendicularly to the film plane. The superlattice film is a thin film formed by layering two types of thin films alternately and artificially, each of the thin films having an atomic scale thickness and containing an element different from that of the other. The superlattice film can thus have physical properties that do not exist naturally. As such superlattice films having large perpendicular magnetic anisotropy energy, there are some well-known ones, each of which is obtained by laminating a ferromagnetic metal (Co, Fe) and a noble metal (Pd, Pt) alternately. The perpendicular magnetic anisotropy is considered to be originated at the boundary between a ferromagnetic metal layer and a noble metal layer. The official gazette of JP-A No. 67322/1993 discloses a perpendicularly magnetized film that uses a Co/Pt superlattice film. And, the official gazette of JP-A No. 67322/1993 proposes a method for reducing the lamination cycles of the superlattice film to obtain a perpendicularly magnetized film even when the ferromagnetic Co content in the superlattice film is comparatively high.

Such a superlattice film is formed by vacuum-depositing a material containing mainly such ferromagnetic exchange metal as Co, Fe, or the like and a material containing mainly such noble metal as Pt, Pd, or the like on the subject substrate using an independent means respectively. At that time, those materials are deposited alternately on the surface of the substrate. For such alternate vacuum-depositing, a shutter may be provided between each depositing source and the substrate or the substrate may be moved between depositing sources. Furthermore, the amount of each material supplied from the depositing source may be changed timely for each vacuum-depositing means.

As such a vacuum-depositing method for mass production of superlattice films, the sputtering method will be effective, since it can produce highly pure films at a comparatively fast vacuum-depositing speed. The official gazette of JP-A No. 141719/2003 discloses an apparatus for manufacturing such superlattice films fast by fixing the position of the object substrate and rotating a plurality of sputtering targets disposed in the same vacuum chamber. The apparatus controls the discharging condition of each cathode independently to obtain a given periodic layer structure. The official gazette of JP-A No. 111403/1994 discloses a method for improving the magnetic characteristic of such superlattice films by changing the sputtering (discharging) gas pressure for each sputtering cathode.

Furthermore, a technique for promoting segregation of magnetic grains from each another is now watched attentively. The technique forms grain boundaries by adding oxide to the subject magnetic metal film. If such a magnetic metal alloy as Co·Cr·Pt or the like and a non-metal material as SiO₂ or the like are vacuum-deposited at the same time under predetermined conditions, mesh-like oxide grain boundaries are formed so as to surround the grain-like magnetic metal alloy, respectively. Media manufactured by this method are generally referred to as granular media. The granular media are proposed first by S. H. Liou et al. as media in which minute magnetic particles of Fe are scattered in a non-magnetic matrix made of non-crystalline SiO₂ (Appl. Phys. Lett. 52 (1988) 512). Because the magnetic grains are segregated from each another by a non-magnetic oxide material, the magnetic exchange-coupling therebetween is weak and the magnetic crystal grains are formed minutely. Thus, the noise of the media is extremely reduced. However, because the thermal demagnetization comes to appear remarkably in the media, the reliability of the media is not enough in the high recording density region.

After that, however, there have been proposed various materials having large magnetic anisotropy energy and manufacturing methods for granular structure media. The official gazette of JP-A No. 311929/1995 discloses a method for using a CoPt alloy for forming magnetic grains, as well as using such an oxide material as Al₂O₃, TiO₂, ZrO₂, Y₂O₃, or the like in addition to the SiO₂ for forming the non-magnetic crystal grain boundary region to disable the intergranular exchange-coupling. The official gazette also discloses a method using nitrides instead of oxides.

To vacuum-deposit a material for forming non-magnetic crystal grain boundaries and a material for forming magnetic grains at the same time, thereby forming the object film using the sputtering method or the like, a ferromagnetic metal target containing oxide or nitride beforehand may be used. It is also possible to prepare an oxide target and a ferromagnetic metal alloy target separately so as to be vacuum-deposited at the same time. It is also possible to use a reactive sputtering method that uses Ar gas containing oxygen or nitrogen or the like. Furthermore, the official gazette of JP-A No. 98835/1995 (vacuum annealing after film deposition), the official gazette of JP-A No. 45073/1996 (high-frequency bias sputtering), etc. discloses other methods for increasing the magnetic anisotropy energy more.

If a non-magnetic metal underlayer that contains mainly Ru is combined with a granular medium containing a CoPt alloy, stronger perpendicular magnetizing anisotropy is obtained. The details of the manufacturing method and its features are disclosed, for example, in the official gazette of JP-A No. 077122/2003. The Co-based alloy crystal structure is a hexagonal closest packed structure and if an Ru underlayer that has the same crystal structure is used, it is easy to realize the crystal orientation that disposes the c axis that is a magnetic easy axis perpendicularly to the film surface. Such comparatively stable crystal orientation is also realized even when SiO₂ or the like is added to the medium. In addition, crystal grain boundaries can be formed of a non-metal material satisfactorily and the magnetic grains come to be formed almost equally in a proper diameter. Because the magnetic easy axis of this granular medium is perpendicular to the film surface, it is applicable to the perpendicular magnetic recording.

In the case of the magnetic recording film made of only a CoCrPt-based alloy having been employed for conventional magnetic disks, a non-magnetic metallic element Cr can be segregated from a magnetic metal Co under certain conditions. This phenomenon is used effectively to segregate the grains into magnetic grains containing comparatively much Co metal and grain boundaries containing comparatively much Cr metal to realize noise reduction. To form such grain boundaries satisfactorily, it has been required to add comparatively much Cr metal (about 20 at %) to the magnetic recording film. However, the residual Cr content in the magnetic grains causes the Kᵤ of the magnetic crystal grains to be reduced even after the segregation of grain boundaries; hence it has been impossible to satisfy the requirements of both of noise reduction and thermal stability when only the CoCrPt-based alloy is used to form the magnetic recording film.

On the contrary, the granular medium, when such a non-metal material as SiO₂ or the like is added thereto, generates non-magnetic grain boundaries, so that the granular medium can apply to various magnetic metal films. For example, if a CoCrPt alloy is used as the magnetic material of the granular medium and the amount of the Cr content in the alloy is controlled under 15 at %, the medium can reduce noise while keeping the Kᵤ value high.

Because the granular medium can form grain boundaries regardless of the type of the magnetic metal material that conducts the magnetism of the magnetic recording medium, the magnetic metal material can be selected more freely. By using a magnetic metal material having a large Kᵤ, the micronized magnetic grains of the medium will be able to realize both of noise reduction and thermal stability of recorded information.

### BRIEF SUMMARY OF THE INVENTION

As described above, in order to realize high recording density for hard-disk drives, the magnetic film is required to be formed so as to have large perpendicular magnetic anisotropy energy Kᵤ while micronized magnetic grains are isolated from each another. In the CoCrPt-based alloy, however, it is difficult to expect that the Kᵤ value is to be improved more than that. The superlattice film generates larger Kᵤ than the conventionally examined CoCrPt-based alloy or suchlike that is used as the magnetic material of a granular medium. If grain boundaries are formed with a non-magnetic material in this excellent magnetic material (=the superlattice film), and a high signal to noise ratio (SNR) is achieved, the magnetic recording medium comes to cope with higher recording density of hard-disk drives.

A magnetic recording film that uses such a superlattice film is disclosed, for example, in the official gazette of JP-A No. 25032/2002. According to this official gazette, the B element is added to both of the Co and Pd targets, then the object film is deposited in an oxygen-containing atmosphere, thereby obtaining the film characteristics appropriate to the magnetic recording medium. Instead of mixing such non-magnetic materials as oxide when in film deposition, if boron is added to both ferromagnetic metal and noble metal of the superlattice film and the film is then subjected to a reactive sputtering process in a rare gas atmosphere containing oxygen or nitrogen when in film deposition, a low density amorphous region is formed in the superlattice film so as to surround the respective magnetic grains. The high resolution EDX spectrum that appears at that time denotes that this amorphous region has a boron-oxide phase containing high density boron and oxygen. The superlattice film showed the improved recording/reproducing characteristic, and is considered to be suitable for magnetic recording media.

The present inventors have confirmed that such amorphous regions that function as grain boundaries are generated surely, and the SNR increases in the superlattice film formed on an experimental basis with reference to the above-described superlattice film manufacturing method, etc. The present inventors have also confirmed that a similar grain boundary structure is formed when such an oxide material as SiO₂, MgO, or the like is added to the superlattice film by modeling after the conventional granular medium.

On the other hand, the present inventors have found that if grain boundaries made of a nonmetallic element are introduced into the conventional superlattice film, the perpendicular magnetic anisotropy energy Kᵤ of the superlattice film often decreases. In those media, the Kᵤ decreases in proportion to an increase of the reactive gas pressure and/or amount of added nonmetal material in a film deposition process. The Kᵤ value of the superlattice film formed under the deposition condition, on which a perfect grain boundary structure is obtained, is under a half of the original Kᵤ, so that the advantage of the superlattice film is lost.

Another problem is that the Kᵤ value is varied among places in the magnetic film when grain boundaries are formed. Reduction of the Kᵤ in the superlattice film denotes local degradation of the magnetism of the superlattice film caused by addition of a non-metal material. And, the Kᵤ decreases more significantly in a local place where the non-metal material is much contained, that is, where grain boundaries are formed comparatively further and grains are small in diameter. Hence, information writing is easy for some magnetic crystal grains and not so easy for some others when in recording.

When in actual magnetic recording, a recording head field having a finite slope of the magnetic field magnitude is used. In the case of a medium having a reversed magnetic field that differs among magnetic metal grains, a “gray region” appears; in such a gray region, grains having a reversed magnetic field respectively and grains having normal magnetic field respectively are mixed at the edge of each recorded magnetic domain. In the evaluation of the recording/reproducing characteristic of the superlattice film manufactured by the present inventors as a trial one, it is found that the recording resolution of this superlattice film, that is, the relative value of the signal output between when in high linear density recording and when in low density recording is lowered significantly than that of the conventional granular media. The assumed reason is that saturation recording becomes difficult when in high linear density recording under the influence of the gray region.

Under such circumstances, it is a feature of the present invention to solve the above problems, realize both of a granular medium structure to be formed using a non-metal material and a high Kᵤ value of an object magnetic material, thereby obtaining a magnetic recording medium usable for higher density recording, as well as providing a method for manufacturing the magnetic recording medium.

The magnetic recording medium according to embodiments of the present invention is a so-called granular magnetic recording medium having a magnetic recording film having magnetic metal grains and a non-magnetic material. In the respective magnetic metal grains of the medium, a magnetic film is formed as an alternately laminated layer including a ferromagnetic exchange metallic element containing mainly Co or Fe and a Pt element that are laminated periodically at periods A within about 0.35 nm to 0.9 nm, more preferably about 0.4 nm to 0.55 nm.

The magnetic recording medium manufactured as described above comes to have perpendicular magnetic anisotropy energy larger than that of an alloy medium having no periodic ordered structure in which the material composition is the same in average. This is because the ferromagnetic alloy and the noble metal are formed in layers, so that the atoms are disposed in those layers so as to promote the perpendicular magnetic anisotropy more than any alloy. In addition, the magnetic recording medium has magnetic easy axes in the periodic layer structure existing direction, so that the magnetic easy axes are easily aligned in the perpendicular direction of the substrate. Consequently, if such a medium is used in a hard-disk drive that employs the perpendicular magnetic recording method, the recording/reproducing characteristic is improved more significantly.

If the lamination period is under about 0.35 nm, however, the periodic layer structure disappears in an atomic scale, so that the effect of the Kᵤ value increased by the employment of the superlattice film is lost, thereby the advantage of the present invention is debilitated. If the lamination period Λ is about 0.4 nm to 0.55 nm, the magnetic recording medium generates a peak Kᵤ value. Therefore, such a lamination period should preferably be selected. If the lamination period Λ further increases, the number of layer interfaces that cause magnetic anisotropy decrease. Thus, the Kᵤ value also decreases. And, if the Λ is over about 0.9 nm, the recording characteristic of the medium is found to be degraded extremely. The degradation seems to be caused by the variation of the magnetic characteristic in the film thickness direction.

According to embodiments of the present invention, therefore, the perpendicular magnetic anisotropy energy that is a feature of the superlattice film can be used effectively while grain boundaries made of a non-metal material are formed in the superlattice film. The present invention can thus provide a granular medium having an excellent effect in the information retaining stability and capable of realizing both lower SNR and higher resolution. In addition, using the method for manufacturing the magnetic recording medium according to embodiments of the present invention makes it possible to obtain a grain boundary structure and a periodic layer structure that are more excellent, thereby improving the performance of the magnetic recording medium. And, using those magnetic recording media will make it possible to further improve the areal recording density of the hard-disk drives.

### BRIEF DESCRIPTION OF THE DRAWINGS

FIG. 1 is a lamination structure of a magnetic recording medium according to an embodiment of the present invention;

FIG. 2 is an overall block diagram of a sputtering apparatus used in a medium manufacturing process;

FIG. 3 illustrates how to dispose rotating cathodes and substrates in the sputtering apparatus;

FIG. 4 illustrates a minute structure of the magnetic recording medium;

FIG. 5 illustrates X-ray diffraction patterns and lamination periods measured with respect to manufactured magnetic recording media;

FIG. 6 illustrates relationships between the magnetic anisotropy energies Kᵤ of the magnetic recording media and their lamination periods;

FIG. 7 illustrates relationships between the coercivities H_{c} of the magnetic recording media and their lamination periods;

FIG. 8 illustrates the magnetic Kerr hysteresis loops measured with respect to a manufactured magnetic recording medium;

FIG. 9 illustrates an overall lamination structure of a dual-layer perpendicular magnetic recording medium;

FIG. 10 illustrates a relationship between the SNR, as well as the resolution, and the lamination period of the dual-layer perpendicular magnetic recording medium;

FIG. 11 illustrates a result of comparison of the perpendicular magnetic anisotropy energy Kᵤ between cases when a granular structure is employed and when no such a structure is employed for the object medium according to another embodiment of the present invention;

FIG. 12 illustrates a relationship between the Kᵤ reduction rate and the ratio of the Pt content in the whole metallic element when a granular structure is employed;

FIG. 13 illustrates a relationship between the amount of Cr added to the Co alloy layer and the medium coercivity according to another embodiment of the present invention;

FIG. 14 illustrates a relationship between the amount of the non-metal grain boundary material (SiO₂) and the medium coercivity when various non-magnetic metal materials are added to the Co alloy layer;

FIG. 15 illustrates a relationship between temperature during the deposition of the magnetic recording film and the medium coercivity H_{c} according to another embodiment of the present invention;

FIG. 16 illustrates a result of comparison of the magnetic Kerr hysteresis loops of a magnetic recording film formed at 60° C. and a magnetic recording film formed at 250° C.;

FIG. 17 illustrates a relationship between the distance between each target and the substrate during deposition and the coercivity of the magnetic recording film according to another embodiment of the present invention; and

FIG. 18 illustrates a relationship between the dispersion of the coercivity H_{c} and T_{Pt} for the media manufactured by two methods.

### DETAILED DESCRIPTION OF THE INVENTION

In the magnetic recording medium according to an embodiment of the present invention, the ratio of the Pt content used as a noble metallic element in the ferromagnetic metal alloy is adjusted between about 10 and 30 at %. Consequently, even when a non-metal material or the like containing oxide or nitride is added to the medium to form a grain boundary structure, the medium comes to have large perpendicular magnetic anisotropy energy Ku, whereby the recording noise is reduced without loosing the stability of the medium against the thermal fluctuation.

The Pt element is a material required to generate magnetic anisotropy energy Ku and the laminated layer structure promotes the pair of Co—Pt atoms to be oriented perpendicularly to the film surface, thereby large perpendicular anisotropy energy Ku is obtained. If such a non-metal material as SiO₂ is added to the medium, however, the electronic state of the Pt element can be disturbed. As a result, the Ku decreases abruptly.

The present inventors have thus examined carefully the relationship between the ratio of the Pt content in the Co alloy and the effect of the addition of such a non-metal material to the medium and found that when the ratio of the Pt content in the subject entire metal is under about 30 at %, such addition of the non-metal grain boundary material have not caused the Kᵤ to decrease almost at all. If the ratio of the Pt content further decreases, however, the Kᵤ comes to decrease flatly in proportion to the decrement of the Pt content. And, if the Pt content decreases excessively, it is hard to obtain a large Kᵤ, although one of the features of the present invention is to obtain a large Kᵤ value. To obtain a large Kᵤ value for the conventional granular medium by making good use of the feature of the present invention, therefore, the ratio of the Pt content must be over about 10 at %.

The present inventors have found in the examination that only the Pt element can obtain a large Kᵤ value if the ratio of contained noble metal decreases such way. If the Pd is used as noble metal to be added, therefore, the Kᵤ takes only a value under a third of the superlattice film having the same laminating structure as that assumed when the Pt is used. The present inventors have also found that if the Pt is used and the ratio of the Pt content in the entire metal of the respective magnetic crystal grains is about 25 at %, the Kᵤ value of the superlattice film having a granular structure reaches the maximum. This means that if three Co atoms are disposed with respect to one Pt atom, the maximum perpendicular magnetic anisotropy is obtained. The ratio of the Pt content, which is 25 at %, is the same as that of a hexagonal CO₃Pt₁ ordered alloy having, as well known, a large Kᵤ value.

Furthermore, the magnetic recording medium of the present embodiment is structured so that each ferromagnetic metal layer is formed so as to contain Ti, Cr, V, Nb, Mo, Ta, and W nonmetallic elements, and then the ferromagnetic metal alloy layer and the Pt layer are layered alternately.

In the case of the Co and Pd or Co and Pt laminated structure having been examined conventionally as a superlattice film, it is found by averaging the values measured in the subject entire film that the ratio of the noble metal content is assumed to be comparatively high. The typical conditions are the Co layer thickness that is about 0.3 nm and the noble metal layer thickness that is about 0.8 nm. In that connection, the ratio of the noble metal content goes over about 70 at % and this does not satisfy the requirement of the present embodiment.

The reason that such a structure is selected is to lower the saturation magnetization of the magnetic recording film to a favorable level (300 to 500 kA/m or so) by raising the ratio of the contained noble metal layer. (If the saturation magnetization is excessively high, the demagnetizing energy that is proportional to the square of the saturation magnetization rises excessively, so that various unfavorable problems come to occur from the magnetic recording medium.) However, in the case of the magnetic recording medium of the present embodiment as described above, the ratio of the Pt content is required to be low. If the ferromagnetic metal layer is made of only Fe or Co, the saturation magnetization in the whole magnetic recording film comes to take a very large value (1000 kA/m or so) unavoidably.

The present embodiment, therefore, adds a non-magnetic material to the ferromagnetic metal layer to obtain a ferromagnetic alloy layer having a comparatively low saturation magnetization value, thereby lowering the saturation magnetization of the magnetic recording film up to a proper value. As a result of the examination by the present inventors, it is found that if the non-magnetic metals are added to the ferromagnetic metal layer, the saturation magnetization is reduced effectively without reducing the Kᵤ value of the magnetic recording film so much. The coercivity of the magnetic recording medium thus increases and the resistance to the thermal fluctuation is secured.

Among the above additives, if Nb, Mo, Ta, and W having a comparatively high fusion point respectively are to be used, the diameter of the respective magnetic metal grains is reduced and this is advantageous for obtaining a high SNR value.

The total amount of the non-magnetic metals added to the ferromagnetic exchange metal should preferably be about 10 to 30 at %. The document J. Appl. Phys. 52 (1980) 2453 reports that if a very small amount (up to 10 at %) of non-magnetic metal is added to a Co alloy, the crystal orientation of the Co alloy layer is degraded. In the examination by the present inventors, it is found that if the amount of an additive is under about 10 at %, Kᵤ and H_{c} are specially reduced. This phenomenon is as described in the above document and it might be caused by the degraded crystal orientation of the magnetic recording film obtained by laminating the ferromagnetic alloy layer and the Pt layer alternately. It is also found that if the total amount of added non-magnetic metals is over about 30 at %, the magnetism of the ferromagnetic alloy layer is lost, thereby the film cannot be used any more as a magnetic recording film even when it is formed as a laminated structure according to the present embodiment.

Manufacturing Method

The method for manufacturing the magnetic recording medium according to the present embodiment may be a conventional superlattice film depositing method. Concretely, the rotating cathode disclosed in the official gazette of JP-A No. 141719/2003 may be used. Non-metal materials required to form a granular structure are vacuum-deposited together with a multi-layer thin film in the deposition process for the multi-layer thin film. If the RF sputtering method or the like is used, it will become easier to vacuum-deposit such non-metal materials as oxide and nitride. A target made of a non-metal material used to form grain boundaries may be prepared separately and deposited together with a ferromagnetic alloy target and a noble metal target in the ternary vacuum deposition process. Otherwise, a metal material target, to which a non-metal material used to form grain boundaries is added beforehand, may be used.

Alloying between vacuum-deposited metal layers is a problem that arises from the above superlattice film depositing method. Each of the particles to be vacuum-deposited and stuck on the substrate surface comes to have average energy determined by the deposition condition. Therefore, the particles might damage the surface on which they are deposited somehow and the sputtered particles themselves move around the substrate surface. This is why an AB alloy layer is often formed between metal layers A and B. If an attempt is made to realize a periodic layer structure requiring a lamination period equivalent to that of a layer consisting of a few atomic monolayers or less just like the magnetic recording medium of the present embodiment, such alloying develops in the whole magnetic film, whereby the predetermined periodic structure might not be obtained.

Although the sputtering method is suitable for mass production of film layers, it is apt to cause the energy of the neutral atoms rebounded from the target and the sputtered particles to increase comparatively. This phenomenon thus occurs more remarkably than other vacuum-depositing methods. If the sputtering method is used to obtain excellent layer interfaces, the following methods are well known; firstly, the pressure of the sputtering gas is raised when in depositing; secondly, the target and the substrates are disposed at longer distances; and the sputtering gas is changed from Ar to Xe or Kr that is rare gas that is larger in atomic weight than Ar (Appl. Phys. Lett. 56 (1990) 2345).

Although those methods are all effective to reduce the motive energy of the sputtering grains, the effect for the sputtered particles coming from a Pt target is different from that for the sputtered particles coming from a ferromagnetic alloy target because the ferromagnetic metals are smaller in atomic weight than Pt. Under the sputtering condition optimized so as to reduce the motive energy of the sputtered Pt particles enough, the energy of the ferromagnetic metal alloy particles goes lower remarkably, whereby it is hard for the ferromagnetic metal alloy particles to reach the substrate. The sputtering rate reduces and is varied among positions of the substrate.

To form an excellent multilayer thin film structure, therefore, an optimal sputtering gas pressure should be selected for each vacuum-depositing source as disclosed in Appl. Phys. Lett. 56 (1990) 2345. However, such a method requires the gas pressure to be changed for each layer of the subject superlattice film. This is why the method is not suitable for fast depositing of multilayer films.

In order to solve the above problem, the method for manufacturing the magnetic recording medium according to an embodiment of the present invention requires no change of the sputtering gas pressure and the sputtering gas type to discharge each target. Instead, the method disposes each target cathode so that the distance from the substrate on which layers are to be deposited (hereinafter, to be referred to the T-S distance) is changed for each target. At that time, the T-S distance of a target containing a material (Pt here) that is larger in atomic weight is required to be longer than the T-S distance of a target containing a material (an exchange metal material here) that is smaller in atomic weight. This method makes it easier to optimally adjust the energy of the sputtered particles flying from each target.

Because the T-S distance is adjusted properly for each target using the sputtering method and the sputtering apparatus as described above, the alloying growth between very thin atomic layers is suppressed. Consequently, it is possible to realize the short periodic lamination layer structure that is a feature of the granular magnetic recording medium of the present embodiment in a perfect state. Such a magnetic recording medium comes naturally to generate still larger perpendicular magnetic anisotropy energy.

When manufacturing the magnetic recording medium of the present embodiment, the depositing time substrate temperature is required to be kept under about 100° C. to promote forming of the non-magnetic grain boundaries in the magnetic recording film. The present inventors, when having examined the manufacturing condition for the magnetic recording medium of the present invention, have found that the coercivity of the magnetic recording film goes lower abruptly regardless of the type of the material of the magnetic crystal grains and the material of non-metal grain boundaries if the substrate temperature goes over about 100° C. when in film depositing.

When observing the targets through electron microscopy, the present inventors have found that the magnetic crystal grains are connected to each another at several places and some of grain boundaries are melted into metal if the temperature goes over about 100° C. in the vacuum-depositing process of the magnetic recording film. The assumed reason is that the non-metal grain boundary material and the magnetic metal grains melt into one another easily under high temperature conditions, whereby segregation of the grains is suppressed.

Evaluation Method

As a means for checking the periodic layer structure of a composition, which is a feature of the magnetic recording medium of the present embodiment, there are some crystal structure analyzing methods including an X-ray diffraction method. If the subject magnetic recording medium has a periodic layer structure in a direction perpendicular to its film surface, a diffraction peak appears corresponding to the period. The lamination period can thus be known by examining the position of this diffraction peak. This diffraction peak intensity is assumed as an index for representing a level of the ordering. In that connection, a diffraction peak corresponding to a periodic layer structure is also seen in a chemically ordered alloy obtained by heating the substrate, for example. In the case of an FePt ordered alloy, there is a face-centered tetragonal fct (001) structure, whose diffraction peak position corresponds just to the period of two monolayers. As described in J. Magn. Soc. Jpn. 21-S2 (1997) 177, etc., the amount of forming an ordered phase can be calculated from the area integrated value of the diffraction ray.

The compositionally periodic layer structure, which is a feature of the present invention, also affects the spectrum shape of the Kerr effect. Consequently, such a spectroscopic method can be used to detect the periodic layer structure. For example, the document Phys. Rev. Lett. 71 (1993) 2493 describes that the CO₃Pt₁ ordered alloy having a large ordering factor S causes the Kerr rotation angle to increase around 3.2 eV. The same method can also be used to determine whether or not such a periodic layer structure is employed for the magnetic recording medium of the present embodiment.

Hereunder, the functions and effects of the present invention will be described with reference to the accompanying drawings on the basis of some concrete embodiments of the present invention. Note that, however, those embodiments are described just to represent the general principles of the present invention; they do not limit the present invention.

### First Embodiment

Hereinafter, the first embodiment of the present invention will be described with reference to some of the accompanying drawings. In this first embodiment, a description will be made particularly for a result of examination for differences between the granular medium of the present invention having a periodic layer structure formed using a multilayer thin film depositing method and a conventional alloy granular medium.

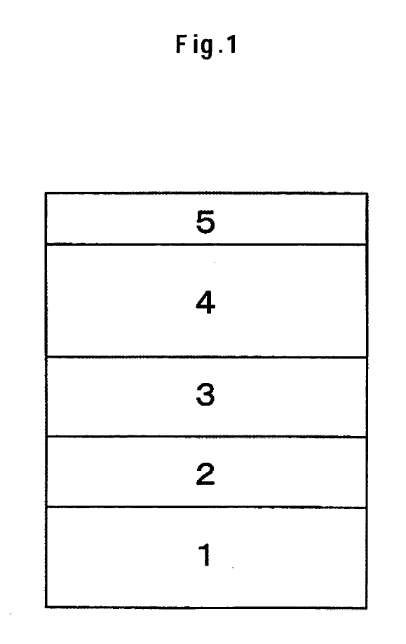

FIG. 1 shows a structure of a perpendicular recording medium without a soft-magnetic underlayer in the first embodiment of the present invention. On a substrate 1 are layered a non-magnetic seed film 2, a non-magnetic underlayer 3, a magnetic recording film 4, and a protective layer 5 in order. Those layers and films were all formed using the sputtering method. Then, the film-deposited substrate 1 was immersed in a bath of lubricant (solution) to apply a coat of lubricant layer on the protective layer 5.

The substrate 1 can be made of any material that has a certain degree of rigidity and heat resistance. Usually, however, one of the NiP-plated aluminum alloy substrate, the enforced glass substrate, the plastic resin injection-molded substrate, etc., that are used as the substrate of magnetic recording media may be used.

The non-magnetic seed film 2 is deposited on the substrate surface directly to improve the close adhesion of the film to the substrate 1, as well as to improve the crystal orientation of the non-magnetic underlayer. Therefore, the material of the seed film should be selected in due consideration of the properties of adhesion and flatness. In this first embodiment, an Ni—Ta amorphous alloy was used and the film thickness was set at 40 nm.

The material of the non-magnetic underlayer 3 should be selected from those capable of controlling the crystal orientation of the magnetic recording film to be deposited just after the underlayer 3 and having a minute irregular surface suitable for realizing a grain boundary structure. For the CoPt-based alloy, such a material as Ru or the like is suitable as described in the official gazette of JP-A No. 077122/2003, for example. The crystal of this material has an hcp structure and the c axis is apt to be oriented perpendicularly to the film surface. In addition, the lattice spacing of the c axis is similar to that of the hcp structure of the CoPt-based alloy. Thus, the CoPt-based alloy for forming magnetic grains makes epitaxial-growth thereon. In addition, the material has a comparatively high melting point, so that the crystal does not grow so easily. An uneven surface, with which a minute grain boundary structure is formed, is thus formed easily. Of course, any underlayer material may be used if it has the characteristics as described above. And, the underlayer may include a plurality of layers. In this embodiment, it is premised that a Co alloy and Pt are used as the main materials of the magnetic recording film 4. The underlayer 3 is made of Ru at a thickness of about 30 nm.

The magnetic recording film 4 is a perpendicularly magnetized film having a granular structure, and a periodic layer structure is applied to the magnetic grains through artificial multilayer thin film depositing using the sputtering method. The details of the concretely applied depositing method will be described later. After the depositing of the magnetic recording film 4, the protective layer 5 is deposited. The protective layer 5 is deposited at a thickness of about 5 nm as a nitride carbonate layer with the sputtering method in an Ar gas atmosphere containing nitrogen.

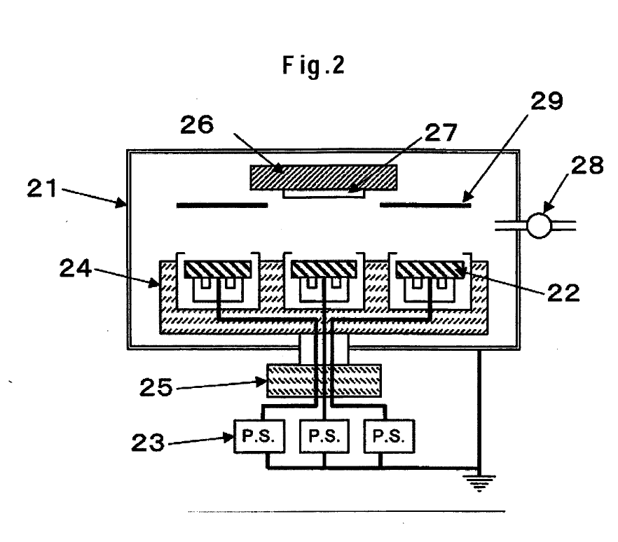

FIG. 2 is a block diagram of a sputtering apparatus used for forming the magnetic recording film 4. The sputtering apparatus is provided with three electrode units 22 in a vacuum chamber 21. Each electrode unit 22 includes a magnet and a cooling water pipe used for magnetron sputtering. A power supply (used for both DC and RF) 23 is attached to the electrode so that it functions as a cathode (negative electrode) with respect to the vacuum chamber 21. Each of those power units 23 can be controlled independently of others. Each electrode unit 22 is mounted on a rotating table 24 and rotated at a given speed by a table rotating mechanism 25. A substrate 27 is fixed in the center of the substrate carrier 26 to be loaded/unloaded into/from the vacuum chamber and moved in the vacuum chamber. When in sputtering, argon gas and a small amount of oxygen gas are introduced into the chamber through a gas inlet port 28. The pressure of each gas and the power supply are set properly, thereby plasma is generated on the surface of each target placed on the surface of an electrode. Then, a predetermined substance flies out from the target and is vacuum-deposited on the substrate 27. In order to prevent the substance from sticking on unexpected portions of the substrate, partition boards 29 are placed at proper positions.

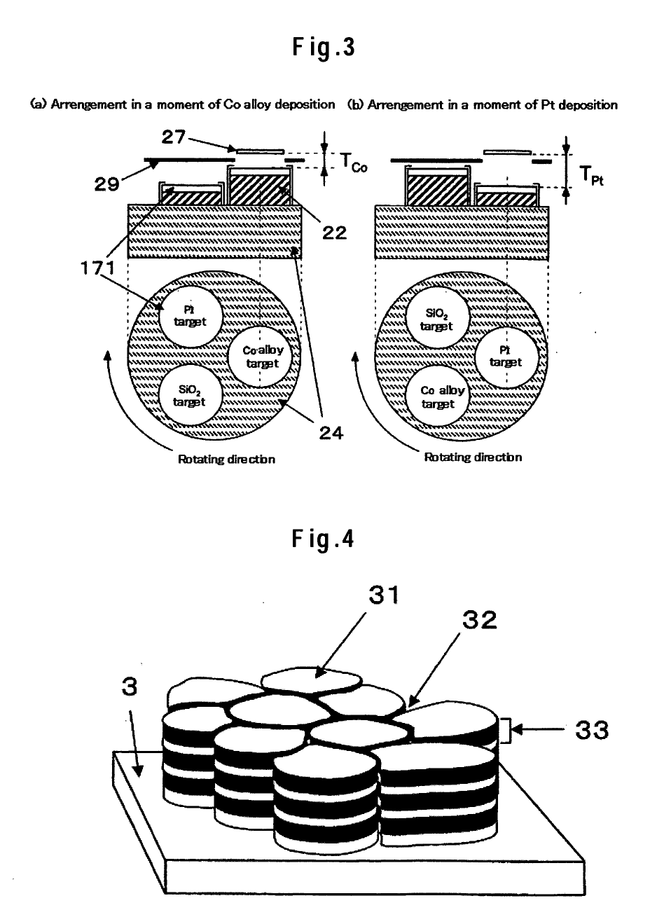

FIG. 3 shows a detailed structure of the sputtering apparatus shown in FIG. 2. The three electrode units 22 provided in the sputtering apparatus are disposed at equal intervals on the same orbit of the rotating table 24 and each electrode unit comes to go round along the orbit of the rotating table (hereinafter, to be generically referred to as the rotating cathode). The power supply 23 provided for each electrode unit 22 can be operated independently of others, so that the depositing speed can be controlled for each target 171. In addition, the height of each electrode unit 22 can be adjusted by an electrode unit moving mechanism. In this first embodiment, the height of each electrode unit 22 was set so that the distance T_{Co} between the Co alloy and the substrate, as well as the distance between the SiO₂ target and the substrate, becomes about 25 mm, and the distance T_{Pt} between the Pt target and the substrate becomes about 65 mm. In FIG. 3(a), the Co alloy target confronts the substrate 27, so that the Co alloy layer is deposited. In FIG. 3(b), the Pt target confronts the substrate 27, so that the Pt layer is deposited.

Three targets, that is, a Co alloy target, a Pt target, and an SiO₂ target were attached to the rotating cathodes for use, respectively. The Co alloy and Pt targets were deposited through DC discharging while the SiO₂ target was deposited through RF discharging. The substrate 27 is fixed at a point on the rotating orbit of the cathode and the cathode is rotated at 20 to 150 rpm, and then all the targets are discharged by a predetermined power at the same time. This method makes it possible to form a periodic layer structure as one lamination period is formed within one rotation of the rotating cathode. In addition, the multilayer structure can thus be produced fast to cope with the mass production thereof. If the thickness corresponding to one lamination period is assumed as Λ and the thickness of the whole magnetic recording film 4 is assumed as t, the total depositing time is calculated as t/Λx (the time required for one rotation). Thus, if t=15 nm, Λ=0.5 μm, and the rotation speed=120 rpm are satisfied, only about 15 seconds is needed to complete the depositing of the whole magnetic recording film 4.

When depositing the magnetic recording film 4, the rotation speed of each rotating cathode and the supply power to the Co alloy and Pt targets are controlled according to the pre-measured sputtering rate of each target to determine the lamination period and the ratio of the Pt content in the whole metallic element. Furthermore, the supply power to the SiO₂ target is controlled to determine the SiO₂ volume ratio to the whole film roughly. The substrate temperature in the depositing process was set at about 60° C. As the sputtering gas, Ar gas was introduced into the chamber at 5 Pa. At the same time, oxygen gas was introduced into the chamber at a partial pressure of 20 to 40 mPa. Although the partial pressure of the oxygen gas differs among lamination periods and among amounts of the introduced SiO₂, the partial pressure was adjusted to obtain the maximum coercivity of the completed magnetic recording film. Addition of the oxygen into the sputtering gas may be effective to reduce the magnetic exchange-coupling between magnetic grains under the influence of the grain boundary structure.

FIG. 4 shows a schematic structure of the magnetic recording film 4 deposited using the above means. The magnetic recording film 4 deposited on the underlayer 3 includes ferromagnetic minute magnetic grains 31 and grain boundaries 32 made of SiO₂ between those crystal grains. Sputtered particles fly out from the targets onto the substrate in the order of a Co alloy, Pt, and SiO₂. The SiO₂ that is oxide is not mixed with other metals and separated out of magnetic metal grains to form grain boundaries, whereby such a granular structure is realized. On the other hand, an Co alloy and Pt are layered at a certain lamination period 33 in the respective magnetic metal grains. The magnetic metal grains are almost circular in shape and about 7.5 nm in average diameter in the film surface direction.

According to the medium manufacturing method described above, therefore, the target discharging condition is fixed for each target and the rotation speed of the rotating cathode is changed to deposit the magnetic recording films 4 in the same composition at various lamination periods. Table 1 shows sputtering conditions for depositing the magnetic recording film 4 of the magnetic recording medium manufactured in this embodiment. Table 1 also shows the ratio of the noble metal (Pt or Pd) contained in the whole metallic element measured by the Electron Spectroscopy for Chemical Analysis (ESCA) method and the volume ratio of the non-metal material estimated from the sputtering rate measured beforehand. The sputtering process was controlled so that the depositing time of the magnetic recording film 4 became 16 seconds for each sample and the rotation speed of the rotating cathode became 30 to 150 rpm. The thickness of the magnetic recording film 4 differs slightly among media groups; however, it is between about 14 and 16 nm.

TABLE 1

| | | | Noble metal target | | | | | |
|---|---|---|---|---|---|---|---|---|
| | | | | | Ratio of | Non-metal target | | |
| | | | | | noble | | | Estimated |
| | | | | | metal | | | grain |
| | Co alloy target | | | | contained | | | boundary |
| Medium | | Sputtering | | Sputtering | in whole | | Sputtering | volume |
| name | Composition | power | Composition | power | metal | Material | power | rate |
| Group A | Co₉₀Ti₁₀ | 400 W | Pt | 150 W | 24% | SiO₂ | 650 W | 22% |
| Group B | Co₈₄Cr₁₆ | 400 W | Pt | 150 W | 19% | SiO₂ | 590 W | 19% |
| Group C | Co₉₀Ti₁₀ | 400 W | Pt | 150 W | 22% | NiO | 390 W | 17% |
| Group D | Co₈₄Cr₁₆ | 440 W | Pt | 150 W | 18% | MgO | 320 W | 15% |
| Group E | Co₈₄Cr₁₆ | 440 W | Pd | 115 W | 24% | SiO₂ | 590 W | 19% |

Hereinafter, a result of comparison among those magnetic recording media will be described.

Lamination Period Dependency—Structure

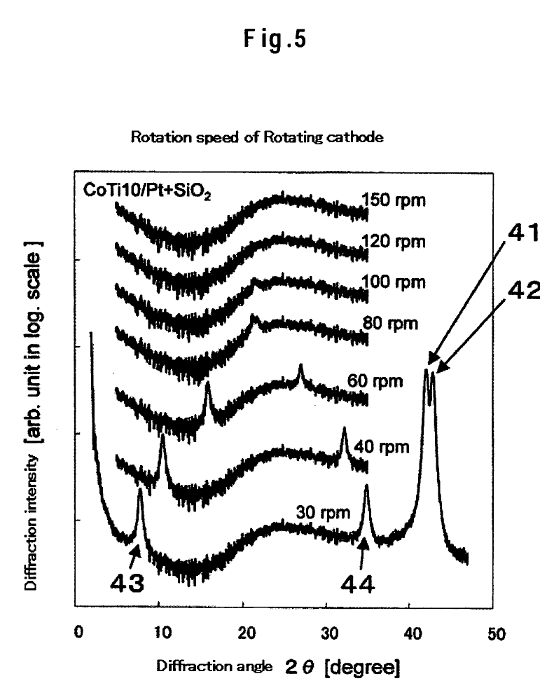

FIG. 5 shows an X-ray diffraction pattern obtained by measuring the magnetic recording media group A shown in Table 1. The diffraction intensity peak at the diffraction angle 2θ=42.2° is the diffraction peak of the Ru underlayer 41, and the diffraction intensity peak at the diffraction angle 2θ=42.8° is the fundamental diffraction peak of the magnetic recording film 42. And, there appears two less diffraction intensity peaks specific to each magnetic recording medium at the lower angle side than that of the main diffraction intensity peak for each of the layers. Those diffraction intensity peaks correspond to the lamination periods introduced to those magnetic recording media. The diffraction peak 43 existing at the lower diffraction angle side denotes the diffraction angle 2θ corresponding to the compositional periodicity and almost satisfies the Bragg condition shown in the following expression (1) with respect to the lamination period Λ.
2Λ·sin θ=λ (1)
Here, the λ denotes a wavelength (0.1452 nm) of the Cu—Kα ray that is an X ray source. A peak that is comparatively closer to the fundamental diffraction peak is referred to a satellite superlattice diffraction peak 44, which appears under the influence of the structural modification of the basic crystal periodic structure. The interval between the fundamental diffraction peak and the satellite superlattice diffraction peak 44 corresponds to a lamination period. FIG. 5 shows a relationship between a lamination period determined on the basis of those diffracted rays and a rotation speed of the rotating cathode.

As the rotation is speeded up and the lamination period is set shorter, the low angle peak moves toward the high angle side and the satellite superlattice diffraction peak moves toward the low angle side. Those peak positions come to match with each other approximately at a half angle of the fundamental diffraction peak. This is the same as the relationship between the (000.2) basic peak and the (000.1) superlattice peak in the document described for the CO₃Pt₁ ordered alloy. In other words, if the lamination period is set very short and one period reaches that of two monolayers, the crystal structure to be obtained becomes actually the same as that of an ordered alloy obtained by such a process as substrate heating. However, unlike any of the conventional techniques, a non-metal material was added to the magnetic recording medium in this embodiment so that the granular structure as shown in FIG. 4 is obtained. This is because an artificial multilayer thin film depositing method was employed in this embodiment to deposit the magnetic recording film 4 at a low temperature.

When the rotational speed of the rotating cathode exceeded 100 rpm, the diffraction intensity of a peak caused by the lamination period, which was positioned at about a half of the fundamental diffraction peak, went lower abruptly. This is because the lamination period goes under that of two monolayers, thereby the alloying makes progress. If no superlattice peak is seen at that time, no lamination period is determined. However, in the following examination process, the lamination period of the media in the same group having a long lamination period was divided by the rotational speed ratio of the rotating cathode to determine a virtual lamination period for convenience.

In this embodiment, a description has been made for how to manufacture the granular medium of the present invention using a sputtering apparatus provided with rotating cathodes. One of the most important items of the present invention's granular medium manufacturing apparatus is that the T-S distance of a target that contains Pt is longer than the T-S distance of a target that contains transition metals. However, the rotating cathodes are not requisite for the manufacturing apparatus. In other words, the manufacturing apparatus is just required to be able to laminate each target material sequentially on the substrate. For example, the power of each target may be changed with time to change the vacuum-depositing speed for the target material to laminate the materials sequentially, thereby manufacturing the granular medium of the present invention.

Lamination Period Dependency—Coercivity and Perpendicular Magnetic Anisotropy

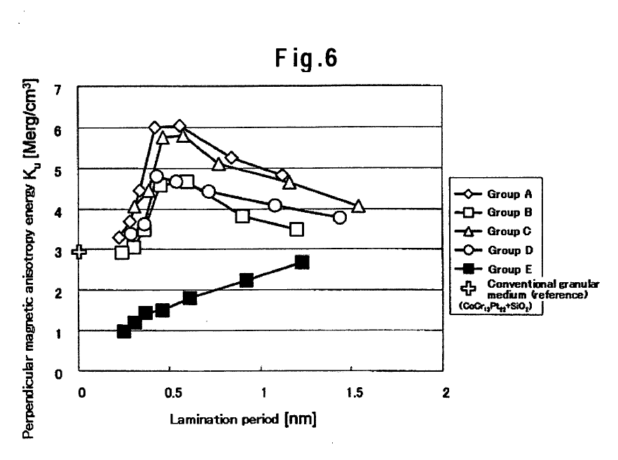

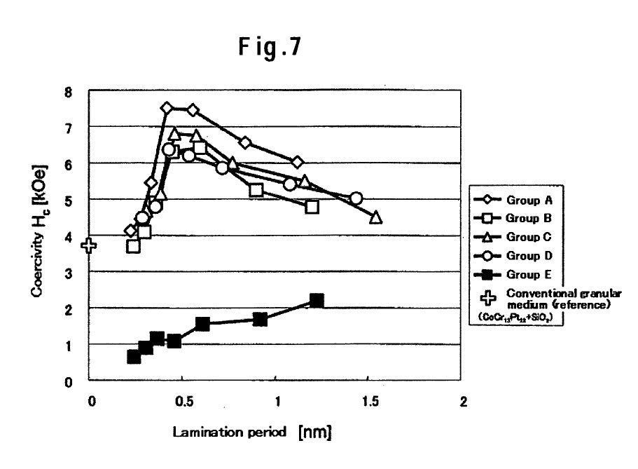

It has been shown that if a ferromagnetic metal alloy and Pt are physically vacuum-deposited alternately using a sputtering multilayer film depositing method as described above, it is possible to form a structure of which composition is changed periodically in the direction perpendicular to the film surface, as well as to form favorable non-magnetic grain boundaries. FIG. 6 illustrates the magnetic anisotropy energy Ku of the magnetic recording media. FIG. 7 illustrates the lamination period dependency of the coercivity H_{c}. Here, the Ku value was obtained by adding the value compensated (2 πMₛ²) by the demagnetizing energy to the value measured by a magnetic torque meter. The H_{c} value was obtained by measuring a hysteresis loop using a Kerr effect measuring apparatus. FIG. 7 also shows measured values of a granular medium manufactured by sputtering both of the CoCr₁₃Pt₂₂ alloy and the SiO₂ at the same time for comparison.

As shown in FIG. 6, the Kᵤ value depends significantly on the lamination period of the magnetic metal grains in the subject medium. In the case of a medium in which the lamination period was short and alloying of the magnetic metal grains makes progress, the Kᵤ value does not differ so much from that of the granular medium consisting of a CoCr₁₃Pt₂₂ alloy and SiO₂.

On the lamination condition that a diffraction intensity peak related to a lamination period was seen in the X-ray diffraction pattern shown in FIG. 5, the Kᵤ value increased abruptly and reached the maximum value around 0.4 to 0.55 nm. As the lamination period got long, the Kᵤ value decreased gradually, but the decrement was not so large. Even when the lamination period was over 1.0 nm, the obtained Kᵤ was larger enough than that of a film in which alloying made progress at a short lamination period. However, the result of the magnetic recording media group E that used Pd for the noble metal layer differed from those of other media. In this media group E, the Kᵤ value increases as the lamination period goes longer. However, the Kᵤ value of the media group E is far smaller than those of other media groups, so that it is not appropriate to any of magnetic recording media.

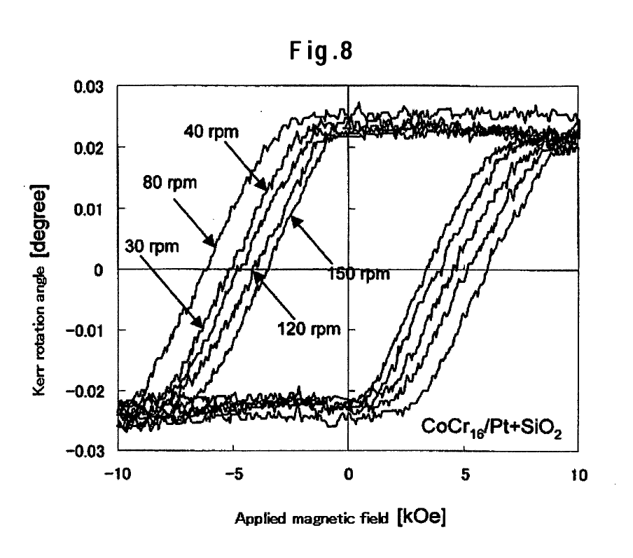

The behavior of the H_{c} shown in FIG. 7 is very similar to that of the Kᵤ and the H_{c} increment/decrement is proportional to that of the Kᵤ. The assumed reason is that the intergranular exchange coupling between magnetic metal grains goes lower due to the granular structure and the medium causes magnetic reversal due to the mechanism similar to the coherent magnetic reversal (Stoner-Wohlfarth type reversal). FIG. 8 shows part of a magnetic Kerr effect hysteresis loop obtained by measuring the magnetic recording medium in the group B. Although the coercivity of the loop depends on the lamination period, the loop inclination makes no change around the coercivity at which irreversible magnetic reversal occurs. This means that the granular structure itself makes no change according to the lamination period and the exchange coupling between magnetic metal grains is similar. Consequently, change in the coercivity H_{c} is not caused by any change of the intergranular exchange coupling, but caused by a difference of the magnetic anisotropy energy Kᵤ.

Lamination Period Dependency—Recording Characteristic

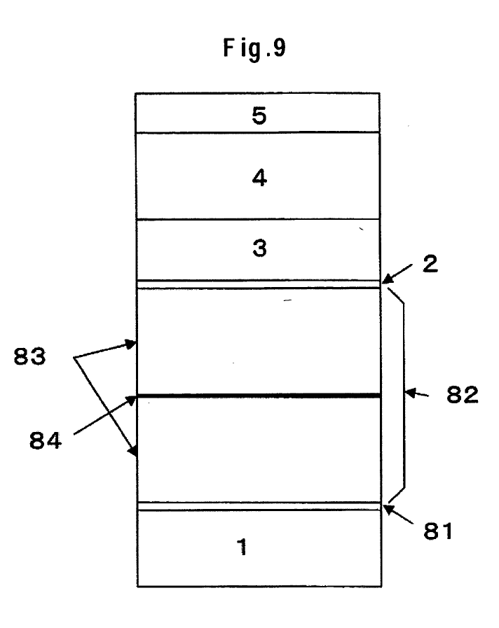

The magnetic recording film (layer) having been examined so far is combined with a soft-magnetic underlayer 82 to manufacture dual layer perpendicular media and to evaluate their recording and reproducing characteristics. FIG. 9 shows an overall structure of the dual layer perpendicular medium. The soft-magnetic underlayer 82 is obtained by laminating a 100 nm FeTaC micro-crystal alloy 83 on another 83 with a thin (about 1 nm) Ta layer 84 therebetween. The soft-magnetic underlayer 82 and the magnetic recording film 4 should preferably be formed to be as closer with each other as possible. Thus, the thickness of the non-magnetic seed layer 2 was determined to be about 3 nm. The Ru underlayer 3 was 30 nm in thickness just like that of a single layer medium. And, an adhesion layer 81 made of an NiTa alloy was provided at the substrate side of the soft-magnetic underlayer 82 to improve the adhesion. The magnetic characteristic of the magnetic recording film 4 was measured using the Kerr effect measuring apparatus and no difference was recognized in the comparison with the single layer medium structured as shown in FIG. 1.

The evaluation of the recording and reproducing characteristics was done at a relative linear speed 6 m/s between the head and the magnetic recording medium. At that time, the flying height of the head was about 14 nm. When recording information on the medium, a single pole type magnetic head having a main pole thickness of 210 nm and a track width of 150 nm was used as the recording magnetic head. When reproducing information, a magnetoresistive head was used as the reading (reproducing) magnetic head. The head had a shield-gap length of 65 nm and a track width of 120 nm. The signal to noise ratio SNR of the signals recorded and reproduced was determined to be a value obtained by dividing the signal reproducing output value when in recording at a recording density of 50 kFCI by an integrated value of the recording noise at a recording density of 400 kFCI. The resolution was obtained by measuring the signal reproduction output with respect to each recording density and the recording linear density D₅₀ was assumed as an index. At the recording linear density D₅₀, the signal reproducing output became a half of the value obtained at a recording density of 50 kFCI.

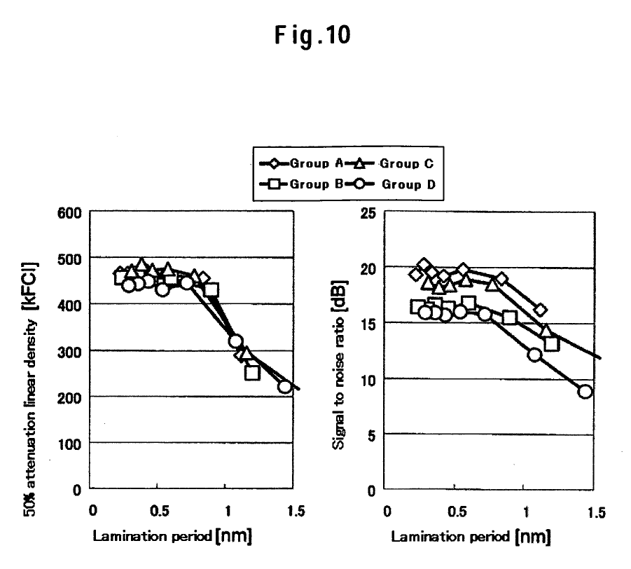

FIG. 10 shows a result of the evaluation. It would be understood in the figure that both of the recording resolution and the SNR are reduced remarkably when the lamination period of the magnetic recording film 4 is over about 0.9 nm. Such reduction of the SNR and the resolution as shown in FIG. 10 causes a serious problem, since it degrades the performance of recording media.

The reason that such degradation occurs in the performance of recording media is not so clear yet. One of the assumed reasons is that if the lamination period is long, a magnetic characteristic difference between a portion around an interface between layers, which generates the perpendicular magnetic anisotropy, and a portion away from the interface exerts an influence adversely on the recording process due to a high frequency magnetic field. Another assumed reason is that the orientation of the Pt element in the magnetic crystal gains changes, whereby the magnetic easy axes come to be dispersed.

The Kᵤ value is proportional to that of the Hₖ value that is an index for denoting the easiness to write. If the Kᵤ value is varied significantly among magnetic metal grains, some grains come to enable easy recording and other grains come to disable easy recording and both types of grains mix together. Both resolution and SNR are thus lowered.

As described in the above embodiment, the magnetic recording medium of the present invention clearly increases the perpendicular magnetic anisotropy energy more than that of any of the conventional alloy granular films. The lamination period that maximizes the perpendicular magnetic anisotropy energy is 0.4 to 0.55 nm. This lamination period is determined by a result of analysis of the superlattice diffraction peak position using the X-ray diffraction method.

### Second Embodiment

In this second embodiment, at first, a description will be made for a result of an examination about the changes in medium characteristics when the Pt content in the respective magnetic metal grains is changed so as to clear the effect of the present invention. The method for manufacturing the magnetic recording film in this embodiment is the same as that in the first embodiment and the medium was also structured as shown in FIG. 1. Table 2 shows a list of depositing conditions for the magnetic recording film 4 in this second embodiment. The sputtering power differed between the Co alloy layer and the Pt layer so as to change the ratio of the Pt content. However, the power was adjusted so as to fix the lamination period almost at 0.5 nm. The rotation speed of the rotating cathode was fixed at 80 rpm. And, two sample media were manufactured; SiO₂ was added to one of the media as a granular film under the optimal condition (22 vol %) and no SiO₂ was added to the other medium. When manufacturing the medium to which no SiO₂ was added, no oxygen was added to the sputtering gas.

TABLE 2

| | | | Noble metal target | | | | | |
|---|---|---|---|---|---|---|---|---|
| | | | | | Ratio of | Non-metal target | | |
| | | | | | noble | | | Estimated |
| | | | | | metal | | | grain |
| | Co alloy target | | | | contained | | | boundary |
| Medium | | Sputtering | | Sputtering | in whole | | Sputtering | volume |
| name | Composition | power | Composition | power | metal | Material | power | ratio |
| Group | Co₉₀Ti₁₀ | 505 W | Pt | 45 W | 10% | SiO2 | 0 W or | 0% or |
| F-1 | | | | | | | 650 W | approx. |
| Group | Co₉₀Ti₁₀ | 450 W | Pt | 85 W | 15% | | | 22% |
| F-2 | | | | | | | | |
| Group | Co₉₀Ti₁₀ | 400 W | Pt | 150 W | 24% | | | |
| F-3 | | | | | | | | |
| Group | Co₉₀Ti₁₀ | 380 W | Pt | 170 W | 30% | | | |
| F-4 | | | | | | | | |
| Group | Co₉₀Ti₁₀ | 365 W | Pt | 195 W | 33% | | | |
| F-5 | | | | | | | | |
| Group | Co₉₀Ti₁₀ | 350 W | Pt | 215 W | 37% | | | |
| F-6 | | | | | | | | |
| Group | Co₉₀Ti₁₀ | 320 W | Pt | 250 W | 43% | | | |
| F-7 | | | | | | | | |

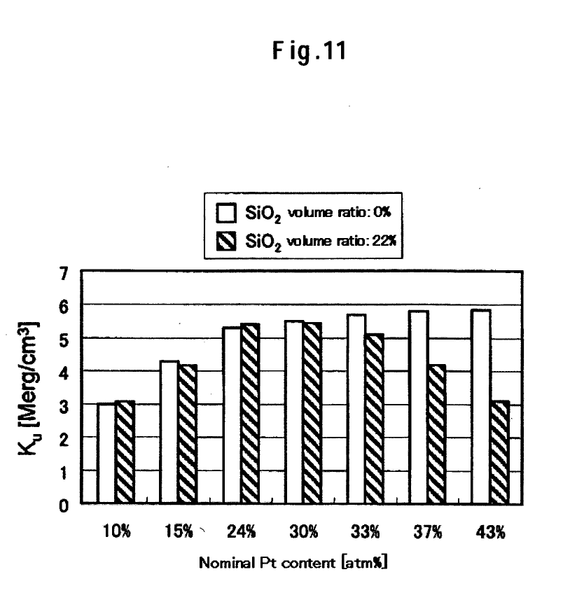

FIG. 11 illustrates a result of comparison among the perpendicular magnetic anisotropy energy values Kᵤ of the group F of magnetic recording media manufactured under the conditions in Table 2. In order to compare each Kᵤ value of magnetic crystal grain cores, the Kᵤ measured in a medium to which no SiO₂ was added is multiplied by 0.78 so as to be shown in FIG. 11. In such a medium (no SiO₂ is added), the Kᵤ increased in proportion to the ratio of the Pt content. If the ratio of the Pt content is over about 10 at % (group F-1), the generated Kᵤ goes over that of the conventional medium having no laminating structure (FIG. 6). On the contrary, in the case where the SiO₂ volume ratio was about 22%, the Kᵤ decreases when the Pt ratio went over 30 at %.

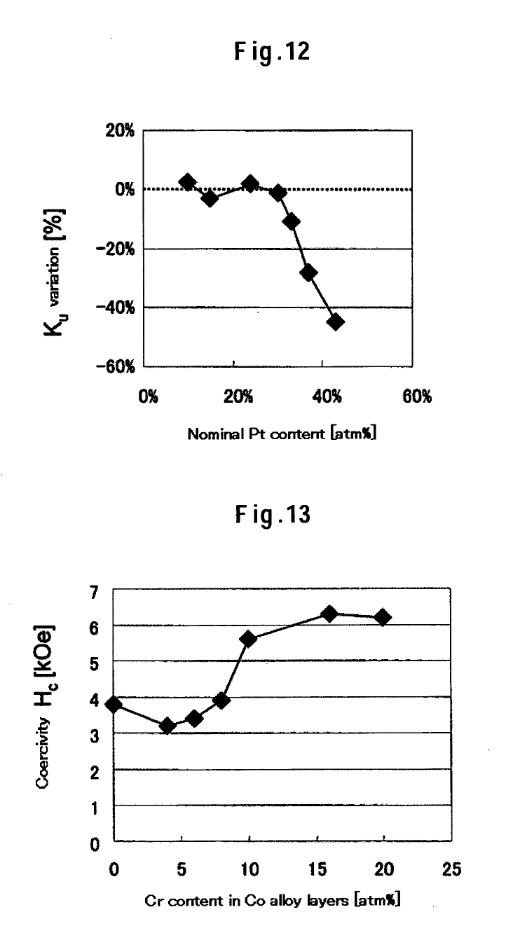

FIG. 12 illustrates how the Kᵤ decreases when SiO₂ was added to the target medium at each ratio of the Pt content. In a medium having a low ratio of the Pt content, the Kᵤ made almost no change. However, when the ratio of the Pt content was over 30%, the Kᵤ decreased significantly in the medium to which SiO₂ was added. In these media in the group F, similar granular structures were recognized in the observation on the minute structure using a transmission electron microscope, and there were no differences in the structures of these media.

The Pt element is very effective to enable the magnetic recording medium of the present invention to generate a large Kᵤ value. But, as to be understood from the above result, the state of the Pt element is easily disturbed; thereby, the Kᵤ value decreases significantly when SiO₂ is added to the film and/or O₂ gas is introduced into the depositing chamber. However, the ratio of the Pt content in respective magnetic crystal grains is under about 30 at %, the magnetic characteristic is stable and can stand addition of a large amount of non-metal material.

If the Kᵤ value is kept from reduction when a non-metal grain boundary material is added to the medium as described above, the thermal stability of the medium assumed as a granular medium is maintained. No reduction in the average Kᵤ value means that the variation of the Kᵤ value is suppressed. The recording characteristic of the medium is thus improved. Among the media in this embodiment, the recording resolution D₅₀ was compared between the group F-2 (Pt element ratio is 15 at %) and the group F-6 (35 at %) using the recording/reproducing test bed employed in the first embodiment and the resolution was 460 kFCI for the group F-2 and only 345 kFCI for the group F-6, though the coercivity of the media was almost equal in both media, which was about 4.1 kOe. The assumed reason is that the significant degradation of the recording resolution of the group F-6 is caused by wide dispersion of the Kᵤ value in that media.

### Third Embodiment

In this third embodiment, a description will be made for a result of comparison among non-magnetic metallic elements added respectively to the Co alloy layer of the magnetic recording medium of the present invention. The magnetic recording medium used in this embodiment was manufactured just like in the first embodiment and structured as shown in FIG. 1. A Co alloy was used as a ferromagnetic alloy. The non-magnetic metal material to be added to the target (Co alloy layer), as well as the ratio of its content were adjusted. The rotation speed of the rotating cathode was set at 80 rpm. And, the sputtering power was adjusted so that the ratio of the Pt content was 22 at % and the lamination period was 0.5 nm.

FIG. 13 illustrates a result of comparison among amounts of the Cr content added to the Co alloy layer. The amount of Cr to be added was changed to within about 0% to 20%. And, SiO₂ was used to form grain boundaries and the sputtering power was adjusted so that the grain boundary volume ratio became about 19%.

When no Cr was added, the obtained coercivity was 3.8 kOe. As for the media with only a few percent of Cr was added, the coercivity decreased though the saturation magnetization Ms of the magnetic recording film decreased slightly. In those media, the perpendicular magnetic anisotropy energy decreases and the magnetic characteristic is found to be rather degraded due to the added Cr.

When the Cr was added more, however, the coercivity increased. When the Cr was added by 10 at %, the coercivity reached 5.6 kOe, which was much more than that when no Cr was added. When the Cr was added by 10 at %, the Ku value was smaller than that when no Cr was added. In that connection, however, the influence of the reduction of the saturation magnetization Ms became dominant, whereby the coercivity increased. When the Cr was added up to 20 at %, the coercivity further went up.

When no Cr is added, the saturation magnetization Ms of the medium itself is excessively high. Thus, the influence of the demagnetizing field energy is strong and it is difficult to stabilize the medium against thermal fluctuation. However, if the Cr is added by about 10% or over, the magnetic recording medium characteristic becomes satisfactory.

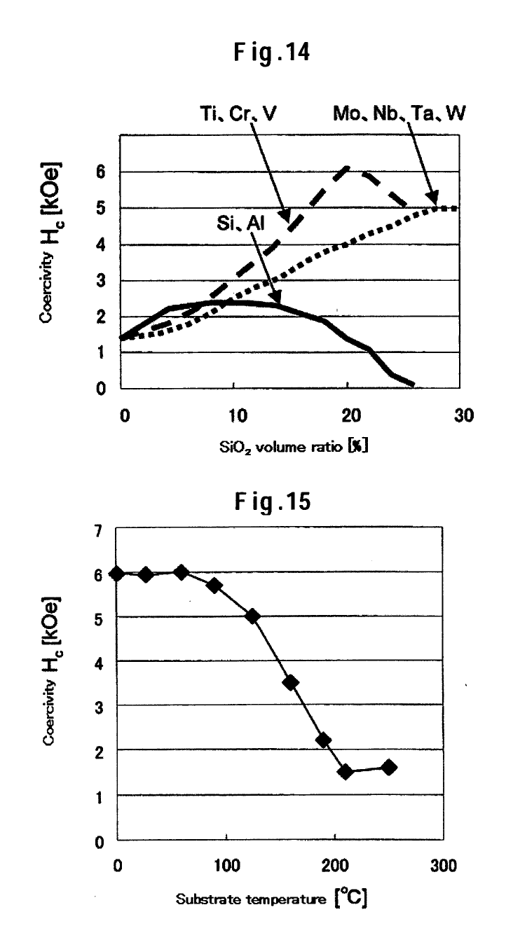

FIG. 14 illustrates a relationship between the volume ratio of SiO₂ added as a grain boundary material and the film coercivity when one of Al, Si, Ti, Cr, V, Nb, Mo, Ta, and W elements is selected as a non-magnetic metal material and added to the object Co alloy. In order to avoid an excessive increase of the number of data items, the additives belonging approximately to the same function are collected and only the functions are indicated. Although the amount of addition is varied slightly among non-magnetic metallic elements, it is adjusted between about 16 and 18 at %.

It is found that the additives are classified into three types according to the SiO₂ volume ratio dependency, as shown in FIG. 14. The Si and Al groups belong to the first type and characterized in that the coercivity does not increase even when a grain boundary material is added to the object, so that they are not suitable as elements to be added to the ferromagnetic metal layer. The Ti, Cr, and V groups belong to the second group. Each of them can have the strongest coercivity. The Mo, Nb, Ta, and W groups belong to the third group. Each of the groups has coercivity which is not larger than that of the second group; however, the coercivity increases even when the grain boundary material volume ratio is high.

Therefore, any of Ti, Cr, V, Mo, Nb, Ta, and W can be added to the ferromagnetic metal layer. The same effect is obtained even when those non-magnetic metals are mixed and added to the ferromagnetic metal alloy layer. Seemingly, the metals in the third group may not be suitable as additives, since their coercivity is low. However, because each of them enables more addition of a grain boundary material, it is expected that the magnetic metal grains come to be formed in small diameter. Hence, they have an advantage to improve the SNR. As a result of the observation of the structure using a TEM, the average grain diameter of the second group was about 7.2 to 8.0 nm while it was about 6.4 to 6.9 nm in the third group. In the latter third group, it was confirmed that the magnetic metal grains were micronized obviously.

### Fourth Embodiment

In this fourth embodiment, a description will be made in detail for a result of comparison among temperatures for depositing the magnetic recording film 4 of the magnetic recording medium of the present invention. In this examination, the depositing means used in the first embodiment was employed to form the lamination structure as shown in FIG. 1. The magnetic recording film 4 was deposited under the depositing condition of the group C of magnetic recording media in Table 1. The rotational speed of the rotating cathode was 60 rpm. And, a substrate heating mechanism and a substrate cooling mechanism were used. The heating mechanism, which used a lamp heater, was provided in another chamber and vacuum-connected to the depositing apparatus shown in FIG. 2, etc., and the cooling mechanism used cooling He gas. The substrate temperature was controlled by those temperature adjusting mechanisms just before the depositing process of the magnetic recording film 4. After the heating and cooling processes, the substrate temperature was measured using a radiation thermometer while the substrate was moved to a depositing position.

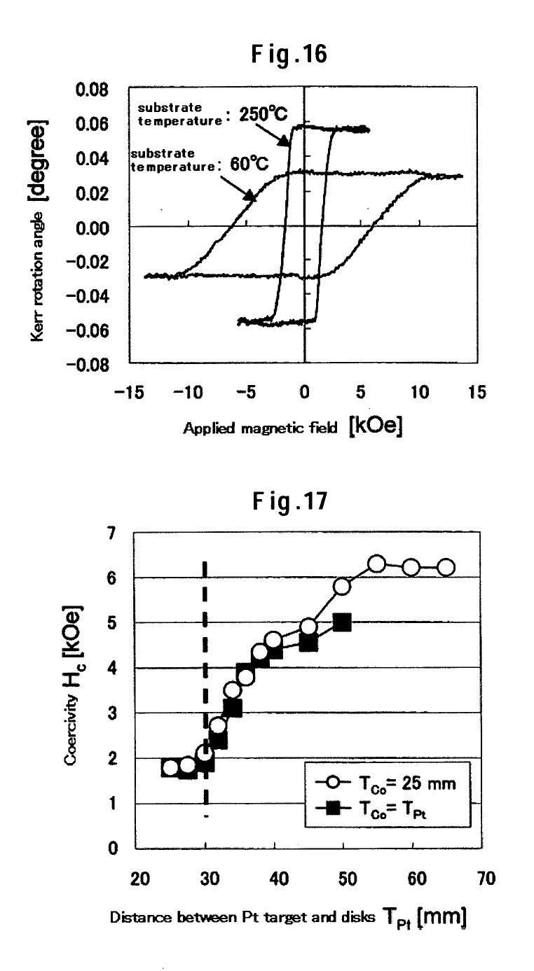

FIG. 15 shows a relationship between the depositing temperature of the magnetic recording film and its coercivity H_{c}. Although the coercivity went lower just slightly from 0° C. to 100° C., the coercivity decreased up to 1.5 kOe from 100° C. and 200° C. FIG. 16 shows a comparison of the magnetic Kerr—effect hysteresis loop between the magnetic recording media manufactured at 60° C. and at 250° C. In the case of the medium manufactured at a higher temperature, the coercivity went lower and the loop slope around the coercivity was very steep. This means that the granular structure is not formed and the intergranular exchange coupling between magnetic metal grains becomes stronger. When the structure was observed through a transmission type electron microscope, it was confirmed that network-like grain boundary regions were formed in the medium manufactured at 60° C. while no such a grain boundary structure was recognized clearly in the medium manufactured at 250° C.

As described above, when manufacturing the granular magnetic recording medium of the present invention, a multilayer depositing should preferably be used without any post-annealing process for promoting chemical segregation, and the substrate temperature should preferably be set under about 100° C.

### Fifth Embodiment

In this fifth embodiment, a description will be made in detail for a result of comparison among the distances between each target and the substrate (T-S distance) during deposition of the magnetic recording film 4. The same method as that in the first embodiment is used to manufacture the medium in this embodiment. And, when depositing the magnetic recording film using a rotating cathode system as shown in FIGS. 2 and 3, the T-S distance T_{Co} of the Co target and the T-S distance T_{Pt} of the Pt target were changed, respectively. The entire lamination structure was the same as that shown in FIG. 1. When in the depositing process for the magnetic recording film 4 by sputtering, the substrate temperature was set at about 60° C., the Ar gas pressure was set at 5 Pa, and the rotation speed of the rotating cathode was set at 80 rpm respectively. The magnetic recording film 4 was structured in the same way as that of the magnetic recording media in the group D. Because a T-S distance was changed to another, the sputtering rate was also changed even when the same sputtering power was used. The sputtering power was thus adjusted to fix the sputtering rate for each of the targets.

Table 3 describes a relationship between the T-S distance and the sputtering power required to fix the sputtering rate. The sputtering slows down more as the T-S distance increases and the sputtering power must be increased correspondingly. The increasing rate of the sputtering power is higher for the Co alloy. This is because the reduction in the kinetic energy of Co alloy sputtering particles is larger than that of the Pt sputtering particles, thereby the Co grains come to be difficult to reach the substrate.

TABLE 3

| | Sputtering power | Sputtering |
|---|---|---|
| | required for | power required |
| T-S distance | CoTi₁₀ target | for Pt target |
| 25 mm | 400 W (standard) | 110 W |
| 30 mm | 490 | 115 W |
| 35 mm | 560 | 115 W |
| 40 mm | 660 | 115 W |
| 45 mm | 850 | 120 W |
| 50 mm | 1250 | 125 W |
| 55 mm | — | 135 W |
| 60 mm | — | 140 W |
| 65 mm | — | 150 W |
| | | (standard) |

FIG. 17 illustrates a relationship between the T-S distance Tpt and the coercivity of each magnetic recording medium manufactured in each Tpt setting. The T-S distance was set by the following two methods. One of the methods is to set the T-S distance T_{Co} for the CoCr alloy at 25 mm just like in the first embodiment and the T-S distance Tpt for the Pt target within 25 to 65 mm. The other method is to equalize the T-S distance for all the targets as T_{Co}=T_{Pt} within 25 to 65 mm. The T-S distance for the MgO oxide target was fixed at 25 mm in both methods.

In the case of the medium manufactured by fixing T_{Co} at about 25 mm, if T_{Pt} was over about 30 mm, that is, at T_{Pt}≧1.2 T_{Co}, the coercivity H_{c} increased significantly. Even in the case of the medium manufactured at T_{Co}=T_{Pt} without changing other conditions including the sputtering gas pressure, the coercivity H_{c} increased similarly. As shown in Table 3, if the T_{Co} distance goes over about 50 mm, the required sputtering power increases excessively. Thus, the sputtering power source and the target cooling efficiency came to arise as problems, so that the medium could not be manufactured by the apparatus in current use.

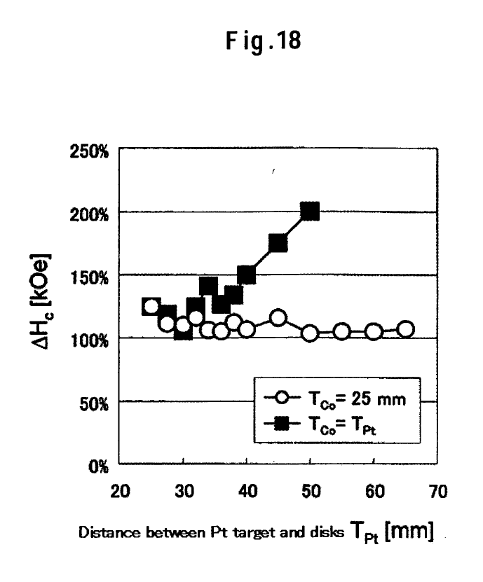

FIG. 18 illustrates the dependence of the dispersion of coercivity H_{c} on the T_{Pt} for the media manufactured using two manufacturing methods in this embodiment. The vertical axis denotes a value obtained by dividing the maximum coercivity value H_{c}_{_{—}}ₘₐₓ of those measured at some points on the medium by the minimum value H_{c}_{_{—}}ₘᵢₙ. In the case of the medium manufactured by fixing the T_{Co} at 25 mm, the H_{c} dispersion does not change so much, the characteristic is equal all over the substrate. In the medium manufactured at Tc₀=T_{Pt}, however, the H_{c} is dispersed widely when the T_{Pt} increases. Needless to say, the medium having such a wide H_{c} dispersion will not be suitable for recording media.

In the case of the multilayer film (superlattice film) depositing method of the present invention, if the energy of the sputtered particles flying to the substrate is large, the interface of the film to be deposited is much destroyed and alloying is advanced there, so that the periodic layer structure is lost. However, the sputtered particle energy and the rebound neutral atom energy are reduced if the T-S distance is set long, thereby a large Kᵤ value is obtained. This is why the medium coercivity increases when the T_{Pt} increases. However, as to be understood from FIG. 17, it is mainly the Pt target that the T-S distance is required to be set longer and the changes of the T-S distance of the Co alloy target can be ignored. The sputtered particles from the Co alloy target are composed of small atoms, so that the periodic layer structure is not influenced almost at all even when the T-S distance is as short as 25 mm. Extending the T-S distance more is not so effective. However, lowering the energy of the sputtered particles from the Pt target is still expected to be effective. Therefore, extending the T-S distance is effective after all.

In the case of the Co alloy target, the sputtering slows down significantly and the productivity of the magnetic recording media drops when the T-S distance Tc₀ exceeds a certain value. This becomes a serious problem. If sputtered particles are scattered extremely by sputtering gas, the depositing rate comes to differ significantly according to the positions on the substrate. In FIG. 18, the film thickness of the Co alloy layer is mainly uneven under the process condition that causes the coercivity H_{c} to be dispersed significantly. Each cathode should therefore be disposed at a T-S distance differently from those of others and the T-S distance of the Co alloy target should be set longer than that of the Pt target so as to increase the Kᵤ value of the subject magnetic recording film effectively without decreasing the productivity.

This is also the same for Fe and Ni, which are ferromagnetic metallic elements other than Co, since their atomic weights are not so different from that of Co. If the sputtering gas is changed to Xe or Kr that are rare gas having a large amount of atoms than Ar or if the sputtering gas pressure is changed, the optimal T-S distance is also changed. Even in that case, the same principle that the T-S distance of the Pt target should be set longer is valid under any condition.

Furthermore, upon an examination of each of the above media for the surface flatness, the magnetic recording medium manufactured by setting only the T-S distance T_{Pt} of the Pt target longer made the medium surface flat more than the medium manufactured by increasing both T_{Pt} and T_{Co}. Generally, such a medium also has an excellent flying property, so that it would be suitable as a magnetic recording medium. The assumed reason is that the energy of the Co alloy sputtered particles that are a main element of the magnetic recording film is kept from excessive decreasing, so that the magnetic crystal grains do not grow abnormally.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

1. A magnetic recording medium, including:
a substrate;
an underlayer formed on said substrate; and
a magnetic recording film formed on said underlayer;
wherein said magnetic recording film is a perpendicularly magnetized film including magnetic metal grains isolated respectively by a gain boundary that contains a nonmetallic element,
wherein said magnetic metal gains are structured respectively as a laminated layer including a ferromagnetic alloy layer and a platinum layer that are laminated periodically at periods Λ, and
wherein the structure of said magnetic metal grains satisfies 0.35 nm≦Λ≦0.9 nm.

2. The magnetic recording medium according to claim 1,
wherein the structure of said magnetic metal gains satisfies 0.4 nm≦Λ≦0.55 nm.

3. The magnetic recording medium according to claim 1,
wherein the platinum content in said metallic element for forming said magnetic metal grains is about 10 to 30 at %.

4. The magnetic recording medium according to claim 1,
wherein said ferromagnetic alloy layer is made of Fe or Co containing at least one of Ti, Cr, V, Nb, Mo, Ta, and W by about 10 to 30 at %, or an alloy of Fe and Co.

5. A magnetic recording medium, including:
a substrate;
an underlayer formed on said substrate; and
a magnetic recording film formed on said underlayer;
wherein said magnetic recording film is a perpendicularly magnetized film formed as a laminated layer including magnetic metal grains isolated respectively by a gain boundary that contains a nonmetallic element;
wherein each of said magnetic metal gains is formed as a perpendicularly magnetized film formed as a laminated layer including a ferromagnetic alloy layer and a platinum layer periodically that are laminated periodically at periods A; and
wherein the platinum content in said metallic element for forming said magnetic metal grains is about 10 to 30 at %.

6. The magnetic recording medium according to claim 5,
wherein said ferromagnetic alloy layer is made of Fe or Co containing at least one of Ti, Cr, V, Nb, Mo, Ta, and W by about 10 to 30 at %, or an alloy of Fe and Co.

7. A method for manufacturing a magnetic recording medium, comprising:
forming an underlayer on a substrate; and
forming a magnetic recording film on said underlayer, said magnetic recording film including magnetic metal grains structured respectively as a periodically laminated layer including a ferromagnetic alloy layer and a platinum layer;
wherein forming said magnetic recording film further includes:
depositing a platinum layer using a spattering method that uses a first target that contains mainly platinum and is separated from said substrate by a distance T_{N}; and
depositing a ferromagnetic metal alloy layer using said spattering method that uses a second target that contains mainly ferromagnetic metal and is separated from said substrate by a distance of T_{M}; and
wherein T_{N}>T_{M} is satisfied.

8. The method according to claim 7,
wherein T_{N}≧1.2 T_{M} is satisfied.

9. The method according to claim 7,
wherein forming said magnetic recording film further includes cooling down said substrate under about 100° C. and uses a non-metal material target to deposit a non-metal material layer using said spattering method.

10. The method according to claim 7,
wherein forming said magnetic recording film uses said first or second target that contains a non-metal material and cools down said substrate under about 100° C.

11. An apparatus for manufacturing a magnetic recording medium having a magnetic recording film that contains magnetic metal grains structured respectively as a periodically laminated layer including a ferromagnetic alloy layer and a platinum layer on an underlayer formed on a substrate, said apparatus comprising:
a substrate carrier configured to retain said substrate;
a table configured to fix at least a first target that contains mainly platinum and a second target that contains mainly ferromagnetic metal;
a vacuum chamber that houses said substrate carrier and said table;
a mechanism configured to introduce sputtering gas into said vacuum chamber;
a mechanism configured to change relative positions of said first target and said second target with respect to said substrate and/or a speed of vacuum-depositing from said first and second targets; and
a power supply configured to power each of said first and second targets independently;
wherein T_{N}≧T_{M} is satisfied if the distance between said first target and said substrate is T_{N} while the distance between said second target and said substrate is T_{M}.

12. The method according to claim 11,
wherein T_{N}≧1.2 T_{M} is satisfied.
